(19) United States
(12) Patent Application Publication
(10) Pub. No.: US 2023/0182670 A1
(43) Pub. Date: Jun. 15, 2023

(54) COLLISION DETERMINATION DEVICE AND VEHICLE HAVING THE SAME

(71) Applicants: Hyundai Motor Company, Seoul (KR); Kia Corporation, Seoul (KR); Pusan National University Industry-University Cooperation Foundation, Busan (KR)

(72) Inventors: Minje Hyun, Hwaseong (KR); Changsun Ahn, Busan (KR); Yeayoung Park, Busan (KR); Juhui Gim, Busan (KR)

(21) Appl. No.: 17/890,008

(22) Filed: Aug. 17, 2022

(30) Foreign Application Priority Data
Dec. 15, 2021 (KR) 10-2021-0179459

(51) Int. Cl. B60R 21/0132

(52) U.S. Cl. CPC B60R 21/0132; B60R 2021/01325; B60R 2021/01327; B60R 2021/01322; B60R 2021/01259

(57) ABSTRACT

The disclosure relates to a collision determination device and a vehicle having the same. The collision determination device comprises a communicator configured communicate with a plurality of sensors, and a processor configured to identify a lateral collision force and a collision moment generated in a vehicle based on detection information of the plurality of sensors received through the communicator, and determine whether a collision of the vehicle occurs based on the lateral collision force and the collision moment.

### CROSS-REFERENCE TO RELATED APPLICATION(S)

This application claims, under 35 U.S.C. § 119(a), the benefit of Korean Patent Application No. 10-2021-0179459, filed on Dec. 15, 2021 in the Korean Intellectual Property Office, the disclosure of which is incorporated herein by reference in its entirety.

### BACKGROUND

### Technical Field

Embodiments of the present disclosure relate to a collision determination device for determining a collision with an obstacle and a vehicle having the same.

### Description of the Related Art

Recently, a variety of advanced driver assistance systems (ADAS) configured to transmit, to a driver, driving information of a vehicle in order to prevent a traffic accident caused by inattentiveness, and configured to transmit guide information for the driver's convenience, are being developed.

For example, the ADAS may comprise a cruise control technology configured to detect distance information about an obstacle around a vehicle by a distance sensor in the vehicle, and configured to adjust a travelling speed of the vehicle based on the detected distance information, and a technology configured to output a warning sound for collision avoidance based on the distance information about the obstacle.

As another example, the ADAS may comprise an autonomous driving technology configured to autonomously travel to a destination based on road information and current location information, and configured to detect an obstacle in order to avoid the obstacle.

Such an ADAS is based on a technology of detecting an obstacle and determining whether a collision occurs between the obstacle and a vehicle.

As an example, an existing collision determination algorithm determines that a collision occurs when a rate of change reaches a predetermined boundary value using a change in yaw angular velocity and a change in lateral acceleration, but works only when a vehicle is moving straight ahead.

Conventionally, when a vehicle changes lanes, a collision determination is incapable of being performed, and when a vehicle rapidly moves without a collision, which is erroneously determined as a collision, causing a malfunction of an ADAS.

Accordingly, a technology capable of determining a collision in various driving conditions and accurately determining a collision with an obstacle is required.

### SUMMARY

An aspect of the present disclosure provides a collision determination device and a vehicle having the same that may, when keeping a driving lane or changing lanes, be configured to estimate a lateral collision force and a collision moment as an external force based on acceleration information, yaw angular velocity information and steering angle information, and may be configured to determine whether a collision occurs based on the estimated external force.

Additional aspects of the present disclosure will be set forth in part in the description which follows and, in part, will be obvious from the description, or may be learned by practice of the disclosure.

According to an aspect of the present disclosure, there is provided a collision determination device comprising: a communicator configured to perform communication with a plurality of sensors; and a processor configured to identify a lateral collision force and a collision moment generated in a vehicle based on detection information of the plurality of sensors received through the communicator, and determine whether a collision of the vehicle occurs based on the identified lateral collision force and the identified collision moment.

The detection information of the plurality of sensors may comprise longitudinal velocity information detected by a speed sensor, lateral acceleration information detected by an acceleration sensor, yaw angular velocity information detected by a yaw sensor, and steering angle information detected by a steering angle sensor.

The processor may be further configured to: predict a state of the vehicle and a covariance matrix based on the detection information of the plurality of sensors, calculate a Kalman gain based on the predicted state of the vehicle and the predicted covariance matrix, correct the state of the vehicle and the covariance matrix based on the Kalman gain, generating a corrected state and a corrected collision force, and identify the lateral collision force and the collision moment based on the corrected state of the vehicle and the corrected covariance matrix.

The processor may be further configured to determine whether the identified lateral collision force is greater than or equal to a reference collision force and the identified collision moment is greater than or equal to a reference collision moment, and when the identified lateral collision force is greater than or equal to the reference collision force, determine that the collision of the vehicle occurs.

The processor may be further configured to determine whether the identified lateral collision force is greater than or equal to a reference collision force and the identified collision moment is greater than or equal to a reference collision moment, when a period of time for which the identified lateral collision force is maintained greater than or equal to the reference collision force is longer than a reference time, determine that the collision of the vehicle occurs, and when the period of time for which the identified lateral collision force is maintained greater than or equal to the reference collision force is less than the reference time, determine that no collision occurs in the vehicle.

The processor may be further configured to configured to determine that no collision occurs in the vehicle, when the identified lateral collision force is less than the reference collision force or the identified collision moment is less than the reference collision moment.

According to another aspect of the present disclosure, there is provided a vehicle comprising: a speed sensor configured to detect a longitudinal velocity; an acceleration sensor configured to detect a lateral acceleration; a yaw sensor configured to detect a yaw angular velocity; a steering angle sensor configured to detect a steering angle; and a processor configured to identify a lateral collision force and a collision moment generated in the vehicle based on longitudinal velocity information detected by the speed sensor, lateral acceleration information detected by the acceleration sensor, yaw angular velocity information detected by the yaw sensor, and steering angle information detected by the steering angle sensor, and determine whether a collision of the vehicle occurs based on the identified lateral collision force and the identified collision moment.

The processor may be further configured to: predict a state of the vehicle and a covariance matrix based on the longitudinal velocity information detected by the speed sensor, the lateral acceleration information detected by the acceleration sensor, the yaw angular velocity information detected by the yaw sensor, and the steering angle information detected by the steering angle sensor, calculate a Kalman gain based on the predicted state of the vehicle and the predicted covariance matrix, correct the state of the vehicle and the covariance matrix based on the Kalman gain, and identify the lateral collision force and the collision moment based on the corrected state of the vehicle and the corrected covariance matrix.

The processor may be further configured to determine whether the identified lateral collision force is greater than or equal to a reference collision force and the identified collision moment is greater than or equal to a reference collision moment, and when the identified lateral collision force is greater than or equal to the reference collision force, determine that the collision of the vehicle occurs.

The processor may be further configured to determine whether the identified lateral collision force is greater than or equal to a reference collision force and the identified collision moment is greater than or equal to a reference collision moment, when a period of time for which the identified lateral collision force is maintained greater than or equal to the reference collision force is longer than a reference time, determine that the collision of the vehicle occurs, and when the period of time for which the identified lateral collision force is maintained greater than or equal to the reference collision force is less than the reference time, determine that no collision occurs in the vehicle.

The processor may be further configured to determine that no collision occurs in the vehicle, when the identified lateral collision force is less than the reference collision force or the identified collision moment is less than the reference collision moment.

The vehicle may further comprise: a brake device configured to generate a braking force, wherein the processor may be further configured to control the brake device based on the lateral collision force and the collision moment, when it is determined that the collision of the vehicle occurs.

The vehicle may further comprise: a steering device configured to change a driving direction of the vehicle, wherein the processor may be further configured to control the steering device based on the lateral collision force and the collision moment, when it is determined that the collision of the vehicle occurs.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram illustrating a vehicle according to an exemplary embodiment;

FIG. 2 is a detailed block diagram illustrating a processor of a vehicle according to an exemplary embodiment;

FIG. 3 is a driving simulation image illustrating that a vehicle according to an exemplary embodiment changes lanes from a first lane to a second lane when 1.5 seconds have elapsed from a start point driving at approximately 80 km/h, and then drives to the first lane;

FIG. 4A is a graph illustrating a lateral acceleration with time when driving as described in FIG. 3, FIG. 4B is a graph illustrating a yaw angular velocity with time when driving as described in FIG. 3, FIG. 4C is a graph illustrating a longitudinal velocity with time when driving as described in FIG. 3, and FIG. 4D is a graph illustrating a steering angle with time when driving as described in FIG. 3;

FIG. 4E is a graph illustrating a lateral collision force with time when driving as described in FIG. 3, and FIG. 4F is a graph illustrating a collision moment with time when driving as described in FIG. 3;

FIG. 4G is a graph that compares the lateral collision force of FIG. 4E and a reference collision force, FIG. 4H is a graph that compares the collision moment of FIG. 4F and a reference collision moment, and FIG. 4I is a graph illustrating a collision determination signal determined according to a result of comparing a lateral collision force identified when driving as described in FIG. 3 with a reference collision force and a result of comparing the collision moment identified when driving as described in FIG. 3 with a reference collision moment;

FIG. 5 is a driving simulation image illustrating that a vehicle according to an exemplary embodiment does a J-turn when 1.5 seconds have elapsed from a start point driving at approximately 80 km/h;

FIG. 6A is a graph illustrating a lateral acceleration with time when driving as described in FIG. 5, FIG. 6B is a graph illustrating a yaw angular velocity with time when driving as described in FIG. 5, FIG. 6C is a graph illustrating a longitudinal velocity with time when driving as described in FIG. 5, and FIG. 6D is a graph illustrating a steering angle with time when driving as described in FIG. 5;

FIG. 6E is a graph illustrating a lateral collision force with time when driving as described in FIG. 5, and FIG. 6F is a graph illustrating a collision moment with time when driving as described in FIG. 5;

FIG. 6G is a graph that compares the lateral collision force of FIG. 6E and a reference collision force, FIG. 6H is a graph that compares the collision moment of FIG. 6F and a reference collision moment, and FIG. 6I is a graph illustrating a collision determination signal determined according to a result of comparing a lateral collision force identified when driving as described in FIG. 5 with a reference collision force and a result of comparing the collision moment identified when driving as described in FIG. 5 with a reference collision moment;

FIG. 7 is a simulation image illustrating that a vehicle according to an exemplary embodiment changes lanes from a first lane to a second lane when 1.5 seconds have elapsed from a start point driving at approximately 80 km/h, and then collides with another vehicle when 2 seconds have elapsed from the start point;

FIG. 8A is a graph illustrating a lateral acceleration with time when driving as described in FIG. 7, FIG. 8B is a graph illustrating a yaw angular velocity with time when driving as described in FIG. 7, FIG. 8C is a graph illustrating a longitudinal velocity with time when driving as described in FIG. 7, and FIG. 8D is a graph illustrating a steering angle with time when driving as described in FIG. 7;

FIG. 8E is a graph illustrating a lateral collision force with time when driving as described in FIG. 7, and FIG. 8F is a graph illustrating a collision moment with time when driving as described in FIG. 7;

FIG. 8G is a graph that compares the lateral collision force of FIG. 8E and a reference collision force, FIG. 8H is a graph that compares the collision moment of FIG. 8F and a reference collision moment, and FIG. 8I is a graph illustrating a collision determination signal determined according to a result of comparing a lateral collision force identified when driving as described in FIG. 7 with a reference collision force and a result of comparing the collision moment identified when driving as described in FIG. 7 with a reference collision moment; and

FIG. 9 is a flowchart illustrating a control of a vehicle according to an exemplary embodiment.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted. The terms such as “˜part”, “˜member”, “˜module”, “˜block”, and the like may refer to at least one process processed by at least one hardware or software. According to embodiments, a plurality of “˜parts”, “˜members”, “˜modules”, “˜blocks” may be embodied as a single element, or a single of a “˜part”, “˜member”, “˜module”, “˜block” may include a plurality of elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but does not preclude the presence or addition of one or more other features, integers, steps, operations, elements, components, and/or groups thereof.

It will be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

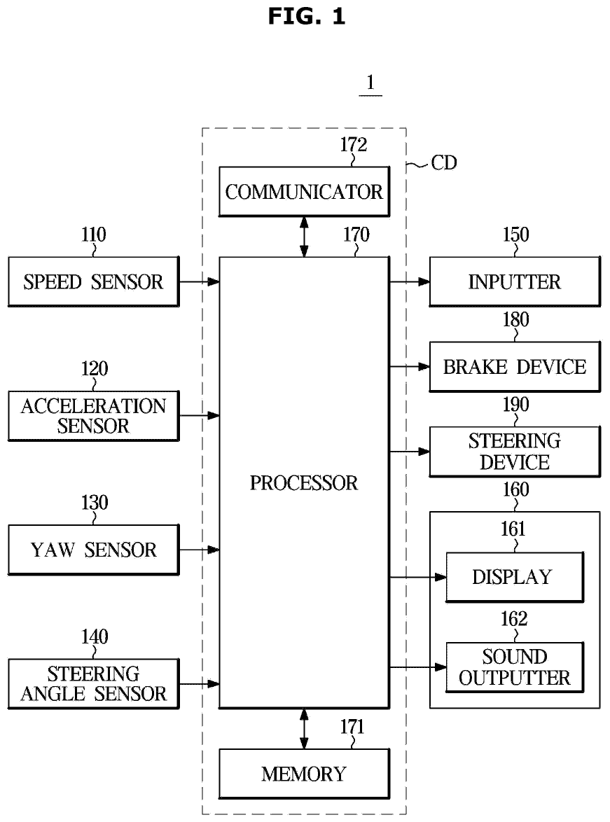

FIG. 1 is a control block diagram illustrating a vehicle according to an exemplary embodiment.

Before describing a control configuration of a vehicle 1, a structure of the vehicle 1 is briefly described.

The vehicle 1 includes a body having an exterior and an interior, and a chassis where mechanical devices for driving are mounted as a remaining portion except for the body.

The body of the vehicle 1 includes a front panel, a bonnet, a roof panel, a rear panel, a plurality of doors and window glasses provided to each of the doors to be able to be open and closed.

The body of the vehicle 1 includes side mirrors for providing a driver with a rear view of the vehicle 1 and an exterior lamp for allowing the driver to easily see surrounding information while keeping an eye on a front and functioning as a signal or a communication with respect to another vehicle and pedestrians.

Inside the body of the vehicle 1, seats provided for an occupant to sit on, a dashboard, an inputter for receiving a user input, and a display for displaying operation information of at least one electronic device may be included. The inputter and the display may be provided in a head unit.

The chassis of the vehicle 1 is a frame for supporting the body of the vehicle 1, and may comprise a power device, a brake device and a steering device for applying a driving force, a braking force, and a steering force to wheels of the vehicle 1, respectively. The chassis of the vehicle 1 may further comprise a suspension device, a transmission device, and the like.

As shown in FIG. 1, the vehicle 1 includes a speed sensor 110, an acceleration sensor 120, a yaw sensor 130, a steering angle sensor 140, an inputter 150, an outputter 160, a processor 170, a memory 171 and a communicator 172. Also, the vehicle 1 may further comprise a brake device 180 and a steering device 190. Here, the processor 170, the memory 171 and the communicator 172 may be constituent components of a collision determination device (CD).

The speed sensor 110 detects a driving speed of the vehicle 1.

The speed sensor 110 may comprise a plurality of wheel speed sensors. The speed sensor 110 may comprise a longitudinal acceleration sensor. The speed sensor 110 may comprise the plurality of wheel speed sensors and the longitudinal acceleration sensor.

When the speed sensor 110 is implemented as the longitudinal acceleration sensor, the processor 170 may be configured to acquire a longitudinal acceleration of the vehicle 1 based on longitudinal acceleration information detected by the longitudinal acceleration sensor, and acquire a driving speed of the vehicle 1 based on the acquired longitudinal acceleration.

When the speed sensor 110 is implemented as the longitudinal acceleration sensor and the plurality of wheel speed sensors, the processor 170 may be configured to acquire the driving speed of the vehicle 1 based on the longitudinal acceleration information detected by the longitudinal acceleration sensor and wheel speed information acquired by the plurality of wheel speed sensors.

The acceleration sensor 120 detects a lateral acceleration of the vehicle 1. That is, the acceleration sensor 120 may be a lateral acceleration sensor, and identify a direction and a magnitude of the lateral acceleration.

The yaw sensor 130 detects a yaw moment of the vehicle 1. That is, the yaw sensor 130 detects a rotation angular velocity in a vertical axis direction of the vehicle 1.

The yaw sensor 130 may be provided in the body of the vehicle 1 such as under a center console, driver's seat, etc., without being limited thereto.

The lateral acceleration sensor and the yaw sensor 130 may be provided as a single sensor. Also, the longitudinal acceleration sensor, the lateral acceleration sensor and the yaw sensor may be provided as a single sensor.

The steering angle sensor 140 detects an angular velocity of a steering wheel to detect a steering angle of the vehicle 1. That is, the steering angle sensor 140 may be an angular velocity sensor.

The inputter 150 receives a user input.

The inputter 150 may be configured to receive an on/off command of a collision warning device and an on/off command of an advanced driver assistance system (ADAS).

The inputter 150 may be provided in a head unit or a center fascia inside the vehicle 1, or in a terminal for vehicle.

The inputter 150 may further comprise a direction indicator lever for indicating a driving direction of the vehicle 1 such as a left turn or a right turn.

The inputter 150 may comprise a hardware device such as various buttons or switches, a pedal, a keyboard, a mouse, a track-ball, various levers, a handle, a stick, and the like.

Also, the inputter 150 may comprise a graphical user interface (GUI) such as a touch pad, i.e., a software device. The touch pad may be implemented as a touch screen panel (TSP) and form a mutual layer structure with a display 161.

In a case of TSP forming a mutual layer structure with the touch pad, the display may be used as an inputter.

The outputter 160 may be configured to output collision warning information in response to a control command of the processor 170.

The outputter 160 may comprise at least one of the display 161 that outputs the collision warning information for notifying the driver of a collision with an obstacle as an image or light, or a sound outputter 162 that outputs the collision warning information as sound.

The display 161 may be configured to display operation information about a function being performed in the vehicle 1. For example, the display 161 may be configured to display information related to a phone call, information about content output through a terminal (not shown), or information related to music reproduction. Also, the display 161 may be configured to display external broadcast information.

The display 161 may be configured to display map information, map information and route guide information where a route to a destination is matched. The display 161 may be configured to display driving direction information such as going straight, turning left, turning right, U-turn, and the like.

The display 161 may be configured to display deceleration information and steering information for avoiding an obstacle as an image.

The display 161 may be configured to display deceleration guide information and steering guide information for preventing a collision with another vehicle as an image.

The display 161 may comprise a lamp such as a light emitting diode (LED), and the like.

The display 161 may be provided as a cathode ray tube (CRT), a digital light processing (DLP) panel, a plasma display panel (PDP), liquid crystal display (LCD) panel, electro luminescence (EL) panel, electrophoretic display (EPD) panel, electrochromic display (ECD) panel, LED panel, organic LED (OLED) panel, and the like, without being limited thereto.

The display 161 may comprise a cluster provided in the vehicle 1.

The cluster may comprise a lamp indicating the collision warning information. The cluster may be configured to turn on or off the lamp in response to a control command of the processor 170.

The cluster may be configured to display an image about the collision warning information.

The sound outputter 162 outputs a sound in response to a control command of the processor 170 at a level corresponding to the control command of the processor 170.

The sound outputter 162 may be configured to output the collision warning information as a sound to warn the driver of a collision with an obstacle. The sound outputter 162 may be a single or two or more speakers.

The sound outputter 162 may be configured to also output a sound for requesting deceleration to prevent a collision with another vehicle.

The sound outputter 162 may be configured to output sound for warning the collision with the other vehicle. The sound for warning may be different according to risk of collision.

The processor 170 may be configured to identify an external force acting on the vehicle 1, determine whether a collision of the vehicle 1 occurs based on the identified external force, and perform collision response control in response to a result of the determination.

The processor 170 may be configured to receive detection information from each of the speed sensor 110, the acceleration sensor 120, the yaw sensor 130 and the steering angle sensor 140. Also, the processor 170 may be configured to acquire longitudinal velocity information, lateral acceleration information, yaw angular velocity information and steering angle information based on the received detection information, and identify the external force based on the acquired longitudinal velocity information, lateral acceleration information, yaw angular velocity information and steering angle information.

The detection information may comprise driving speed information detected by the speed sensor 110, the lateral acceleration information detected by the acceleration sensor 120, the yaw angular velocity information detected by the yaw sensor 130, and the steering angle information detected by the steering angle sensor 140.

The processor 170 may be configured to acquire a longitudinal velocity based on the driving speed information.

The processor 170 may be configured to identify a lateral collision force and a collision moment generated in the vehicle 1 as the external force.

The processor 170 compares the identified lateral collision force with a reference collision force, and compares the identified collision moment with a reference collision moment.

The processor 170 may be configured to determine that a collision of the vehicle 1 occurs, when the identified lateral collision force is greater than or equal to the reference collision force and the identified collision moment is greater than or equal to the reference collision moment.

When the identified lateral collision force is greater than or equal to the reference collision force and the identified collision moment is greater than or equal to the reference collision moment, the processor 170 may be configured to identify a period of time for which the identified lateral collision force is maintained greater than or equal to the reference collision force, and when the identified period of time is longer than a reference time, determine that the collision of the vehicle 1 occurs.

The processor 170 may be configured to determine whether the vehicle 1 is travelling straight ahead or changing lanes based on operation information of the direction indicator lever and the steering angle information of the vehicle 1, and determine whether the collision of the vehicle 1 occurs based on a driving state of the vehicle 1.

The processor 170 may be configured to determine whether the collision of the vehicle 1 occurs using only inertia sensors such as the speed sensor 110, the acceleration sensor 120, the yaw sensor 130 and the steering angle sensor 140 basically provided in the vehicle 1.

When it is determined that the collision occurs between the vehicle 1 and the obstacle, the processor 170 may be configured to control at least one of the brake device 180 or the steering device 190 to prevent the vehicle 1 from rotating or deviating from a driving lane.

When it is determined that the collision occurs, the processor 170 may be configured to control the brake device 180 based on the lateral collision force and the collision moment. When it is determined that the collision occurs, the processor 170 may be configured to control the steering device 190 based on the lateral collision force and the collision moment.

When it is determined that the collision occurs between the vehicle 1 and the obstacle, the processor 170 may be configured to also control an output of the collision warning information.

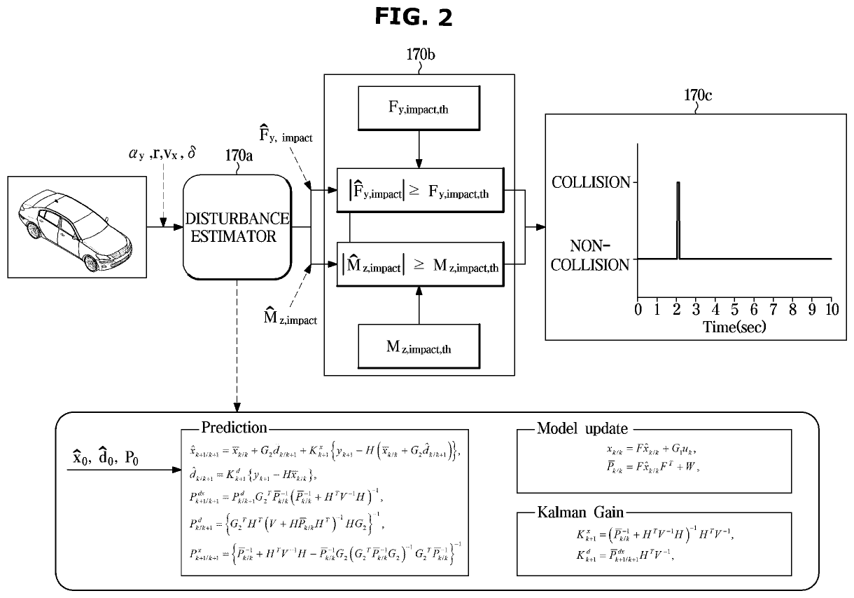

As shown in FIG. 2, the processor 170 may comprise a disturbance estimator 170A, a comparator 170B and a determiner 170C for identifying the external force acting on the vehicle 1.

The disturbance estimator 170A may comprise a Kalman filter. The Kalman filter may be an optimal way to combine data obtained from different sources or a same source at different times. In the Kalman filter, once known information exists and new information is acquired thereafter, weights are given to each piece of information based on a certainty of the known information and the new information. The Kalman filter determines whether to update the known information using a weighted combination of two pieces of information.

As shown in FIG. 2, the disturbance estimator 170A predicts a state of the vehicle 1 and a covariance matrix based on a variable Xo of an initial prediction system, an initial prediction disturbance do and an initial prediction system state covariance matrix P₀.

Here, \hat{x}₀, \hat{d}₀, P₀ may be an initial predicted value.

The predicted state of the vehicle 1 may comprise \hat{x}_{k+1 k+1} for a system variable x with time, and \hat{d}_{k k+1} for an estimated disturbance d with time.

The predicted covariance matrix may comprise a system state covariance matrix P^{x} for the system variable x, a system state covariance matrix P^{d} for the estimated disturbance d, and a system state covariance matrix P^{dx} for the system variable x and the estimated disturbance d.

P, V and W are values used in a general Kalman filter algorithm. The P is a system state covariance matrix, the V is a covariance matrix for a measurement noise, and the W is a covariance matrix for a model uncertainty. Here, the P may be updated.

The disturbance estimator 170A may be configured to obtain a gain based on a system state covariance matrix p̅, the covariance matrix V for the measurement noise, and a discretized form H of an output matrix. Here, the gain may be a Kalman gain.

In this instance, the disturbance estimator 170A may be configured to obtain a Kalman gain K^{x} for the system variable x, and a Kalman gain K^{d} for the estimated disturbance d.

The system variable may comprise a lateral speed and a yaw rate, and the estimated disturbance may comprise a lateral force F_{y.impact} and a yaw moment M_{z.impact} by an impact.

The disturbance estimator 170A may be configured to correct the state of the vehicle 1 and the covariance matrix based on the obtained gain. (Model update in FIG. 2)

The disturbance estimator 170A may be configured to correct a measured value y based on the corrected vehicle state and covariance matrix, and estimate a disturbance based on the corrected measured value. Here, estimating the disturbance may comprise identifying the lateral force F_{y.impact} and the yaw moment M_{z.impact} by the impact.

The disturbance estimator 170A may be configured to estimate a disturbance using a system model based on a linear vehicle model.

An equation of the system model based on the linear vehicle model is as below.

$$\dot{x} = [ \begin{matrix}\dot{v} \\ \dot{r}\end{matrix} ] = AX + {B}_{1} U + {B}_{2} D = [ \begin{matrix}\frac{- ( {C}_{α f} + {C}_{α r} )}{{mu}_{0}} & \frac{{bC}_{α r} - {aC}_{α f}}{{mu}_{0}} \\ \frac{{bC}_{α r} - {aC}_{α f}}{{I}_{zz} {u}_{0}} & \frac{- ( {a}^{2} {C}_{α f} + {b}^{2} {C}_{α r} )}{{I}_{zz} {u}_{0}}\end{matrix} ] [ \begin{matrix}v \\ r\end{matrix} ] +$$

$$[ \begin{matrix}\frac{{C}_{α f}}{m} \\ \frac{{aC}_{α f}}{{I}_{zz}}\end{matrix} ] {δ}_{f} + [ \begin{matrix}\frac{1}{m} & 0 \\ 0 & \frac{1}{{I}_{zz}}\end{matrix} ] [ \begin{matrix}{F}_{y , impact} & {M}_{z , impact}\end{matrix} ]$$

$$y = CX = [ \begin{matrix}\frac{- ( {C}_{α f} + {C}_{α r} )}{{mu}_{0}} & \frac{{bC}_{α r} - {aC}_{α f}}{{mu}_{0}} \\ 0 & 1\end{matrix} ] [ \begin{matrix}v \\ r\end{matrix} ]$$

x: system variables

y: measured values (lateral acceleration, yaw rate)

A: system matrix

B₁: input matrix

B₂: disturbance matrix

C: output matrix

X: system variables

U: input

D: disturbance

δ_{f}: steering angle

v: lateral velocity

r: yaw rate

I_{zz}: yaw inertia

m: vehicle weight

a: front tire C.G

b: rear tire C.G

C_{αf}: front cornering stiffness

C_{αr}: rear cornering stiffness

F_{y,impact}: lateral force by impact

M_{z,impact}: yaw moment by impact

u₀: vehicle speed

An equation transformed by Kalman filter is as below.

Xₙ₊₁=FXₙ+G₁U+G₂D

Yₙ=HXₙ

Here, F, G₁, G₂ and H are discretization forms of matrices A, B₁, B₂ and C, respectively. Here, H, G₁ and G₂ are discretized time-based systems.

The disturbance estimator 170A may be configured to estimate the disturbance (F_{y.impact} and M_{z.impact}) by applying the system model based on the linear vehicle model to the Kalman filter.

The comparator 170B identifies a lateral collision force and a collision moment from the external force identified by the disturbance estimator 170A, compares the identified lateral collision force with a reference collision force stored in advance, and compares the identified collision moment with a reference collision moment stored in advance.

In this instance, the comparator 170B may be configured to compare an absolute value of the identified lateral collision force with the pre-stored reference collision force, and compare an absolute value of the identified collision moment with the pre-stored reference collision moment.

The determiner 170C determines that a collision of the vehicle 1 occurs, when the identified lateral collision force is greater than or equal to the reference collision force and the identified collision moment is greater than or equal to the reference collision moment.

When the identified lateral collision force is less than the reference collision force and the identified collision moment is less than the reference collision moment, the determiner 170C may be configured to determine that no collision occurs. In this case, the determiner 170C may be configured to determine that the vehicle 1 rapidly moves.

The collision determination according to the embodiment is described as an example.

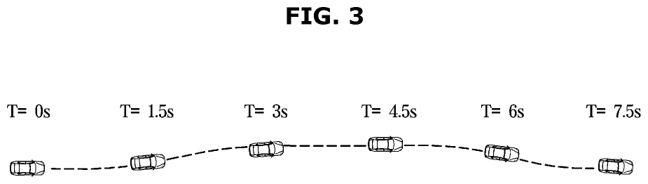

FIG. 3 is a driving simulation image illustrating that a vehicle according to an exemplary embodiment changes lanes from a first lane to a second lane when 1.5 seconds have elapsed from a start point driving at approximately 80 km/h, and then drives to the first lane.

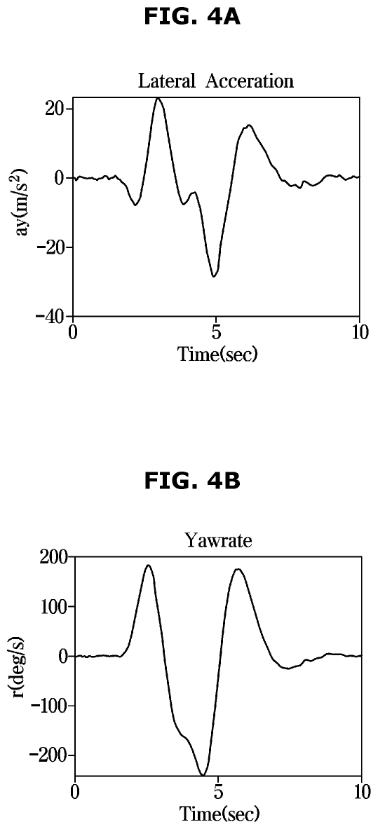

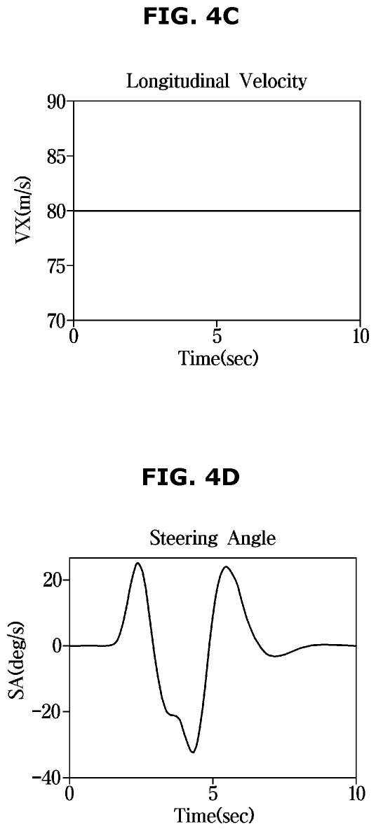

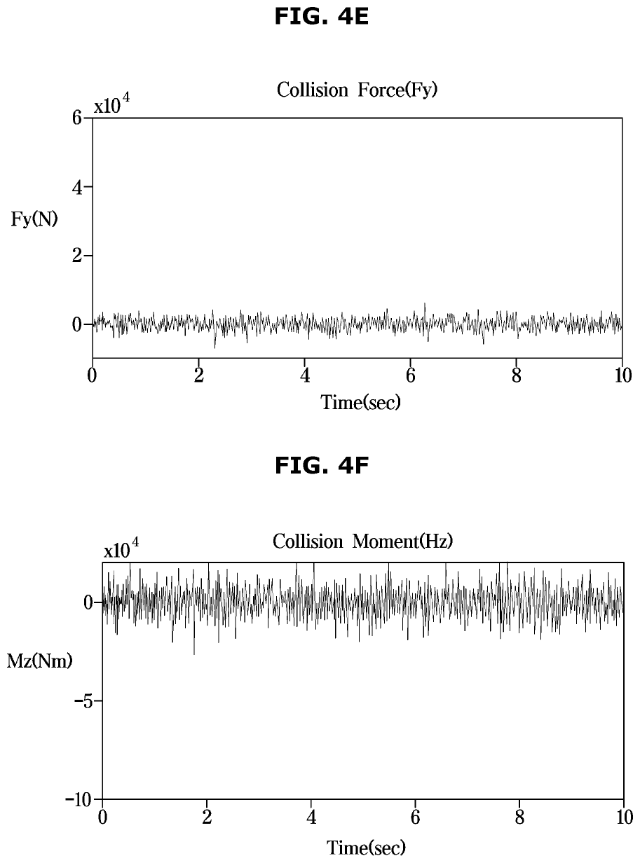

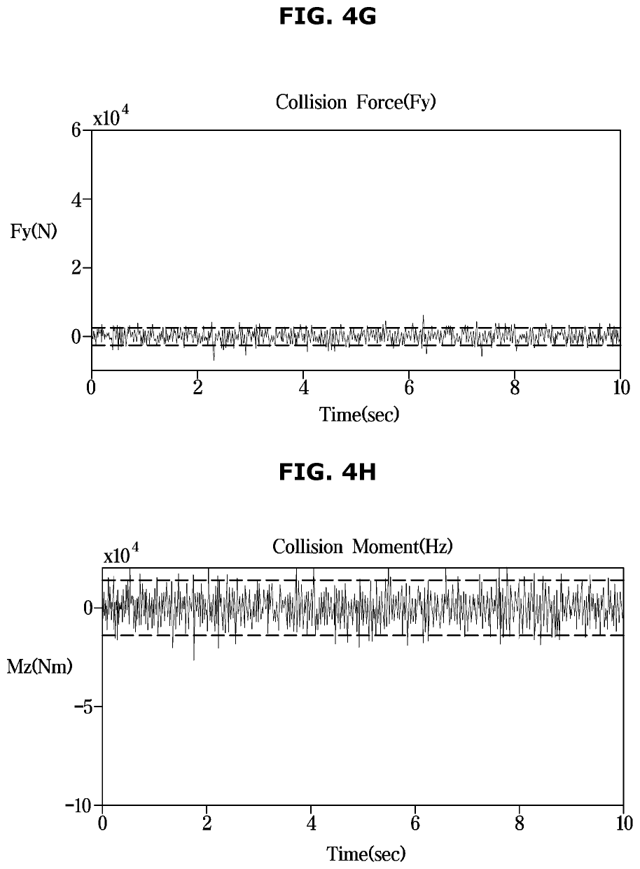

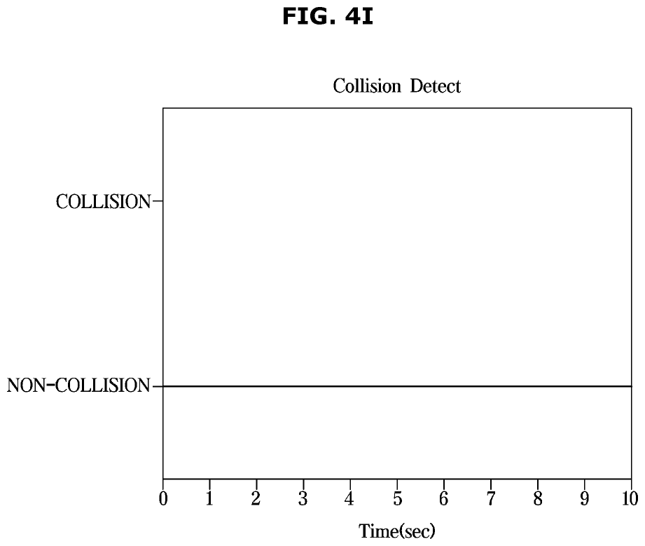

FIG. 4A is a graph illustrating a lateral acceleration with time when driving as described in FIG. 3, FIG. 4B is a graph illustrating a yaw angular velocity with time when driving as described in FIG. 3, FIG. 4C is a graph illustrating a longitudinal velocity with time when driving as described in FIG. 3, and FIG. 4D is a graph illustrating a steering angle with time when driving as described in FIG. 3.

FIG. 4E is a graph illustrating a lateral collision force with time when driving as described in FIG. 3, and FIG. 4F is a graph illustrating a collision moment with time when driving as described in FIG. 3.

FIG. 4G is a graph that compares the lateral collision force of FIG. 4E and a reference collision force, FIG. 4H is a graph that compares the collision moment of FIG. 4F and a reference collision moment, and FIG. 4I is a graph illustrating a collision determination signal determined according to a result of comparing the lateral collision force identified when driving as described in FIG. 3 with the reference collision force and a result of comparing the collision moment identified when driving as described in FIG. 3 with the reference collision moment.

As such, the vehicle 1 according to the embodiment does not determine a rapid movement of the vehicle 1 due to changing lanes as a collision of the vehicle 1.

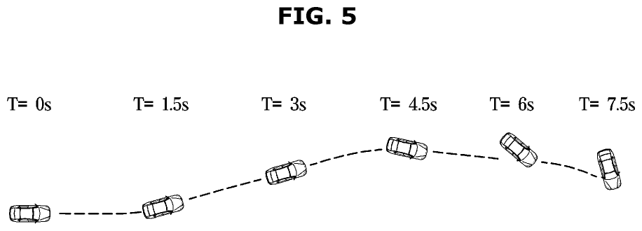

FIG. 5 is a driving simulation image illustrating that a vehicle according to an exemplary embodiment does a J-turn when 1.5 seconds have elapsed from a start point driving at approximately 80 km/h.

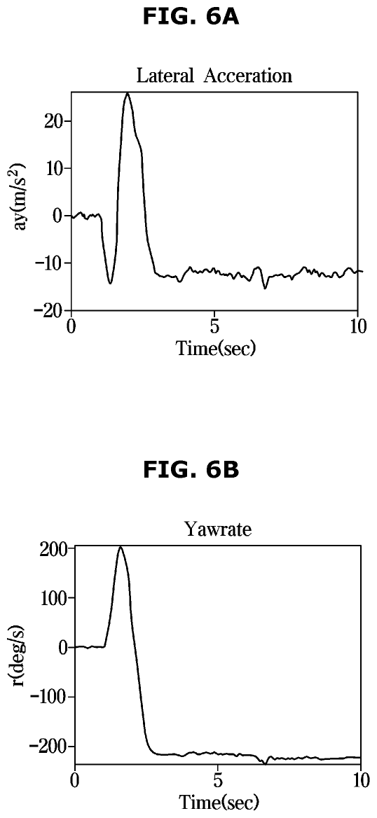

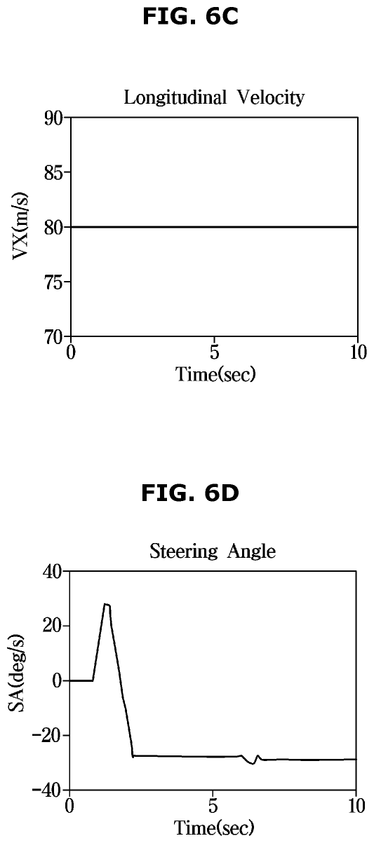

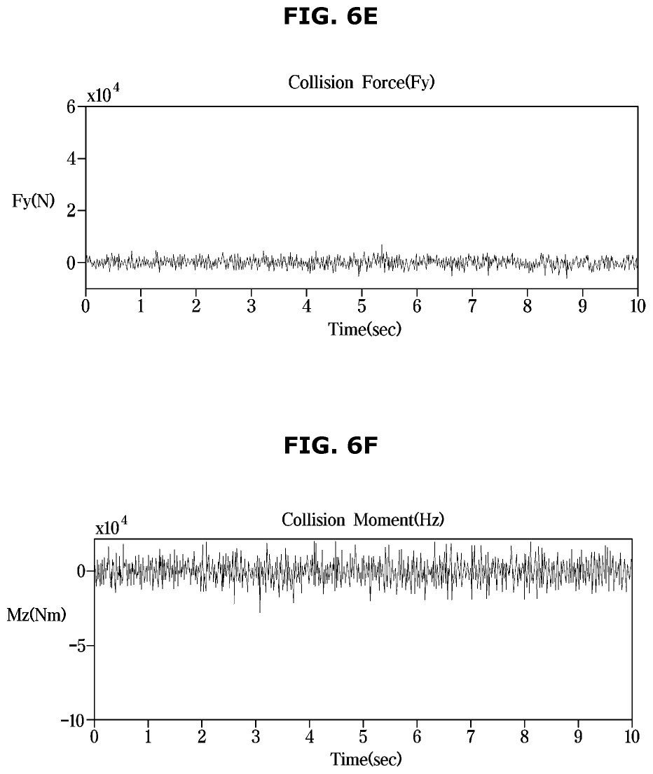

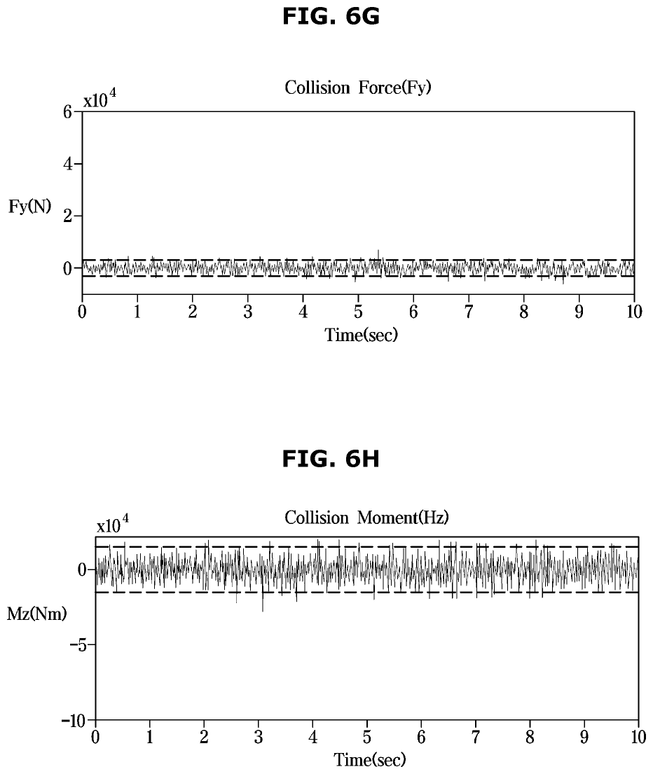

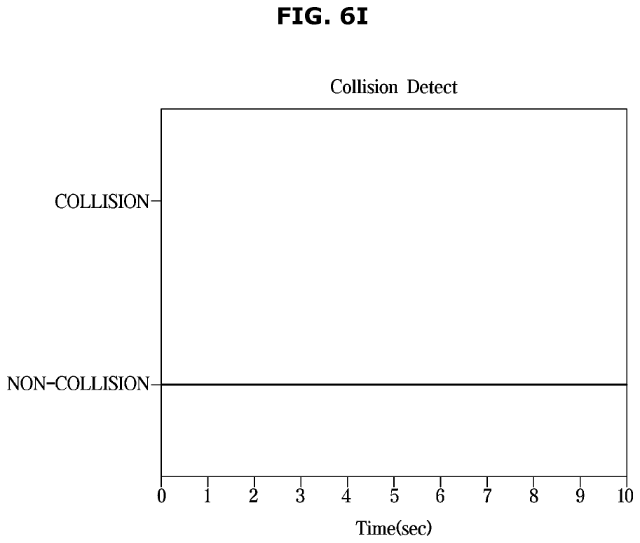

FIG. 6A is a graph illustrating a lateral acceleration with time when driving as described in FIG. 5, FIG. 6B is a graph illustrating a yaw angular velocity with time when driving as described in FIG. 5, FIG. 6C is a graph illustrating a longitudinal velocity with time when driving as described in FIG. 5, and FIG. 6D is a graph illustrating a steering angle with time when driving as described in FIG. 5.

FIG. 6E is a graph illustrating a lateral collision force with time when driving as described in FIG. 5, and FIG. 6F is a graph illustrating a collision moment with time when driving as described in FIG. 5.

FIG. 6G is a graph that compares the lateral collision force of FIG. 6E and a reference collision force, FIG. 6H is a graph that compares the collision moment of FIG. 6F and a reference collision moment, and FIG. 6I is a graph illustrating a collision determination signal determined according to a result of comparing the lateral collision force identified when driving as described in FIG. 5 with the reference collision force and a result of comparing the collision moment identified when driving as described in FIG. 5 with the reference collision moment.

As such, the vehicle 1 according to the embodiment does not determine as a collision even when a rapid movement occurs in response to a J-turn.

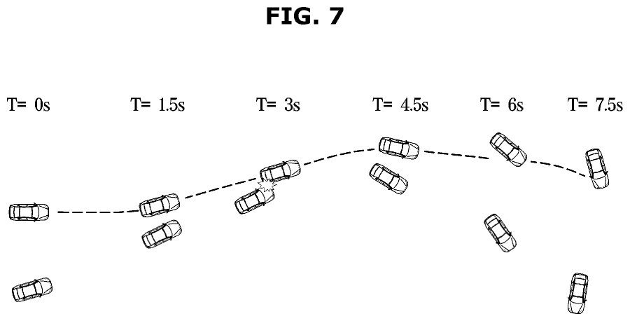

FIG. 7 is a simulation image illustrating that a vehicle according to an exemplary embodiment changes lanes from a first lane to a second lane when 1.5 seconds have elapsed from a start point driving at approximately 80 km/h, and then collides with another vehicle when 2 seconds have elapsed from the start point.

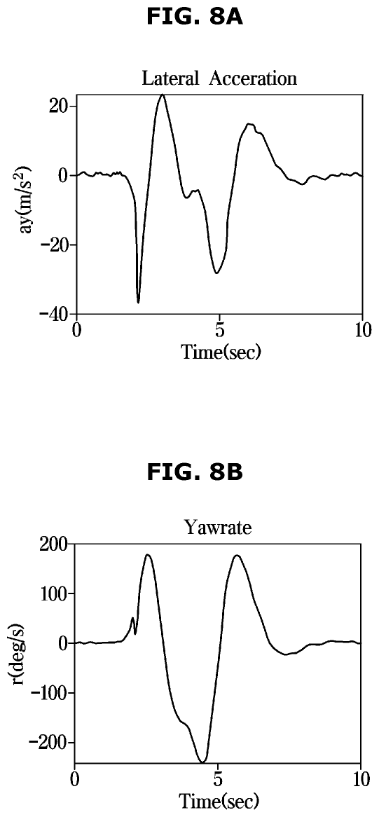

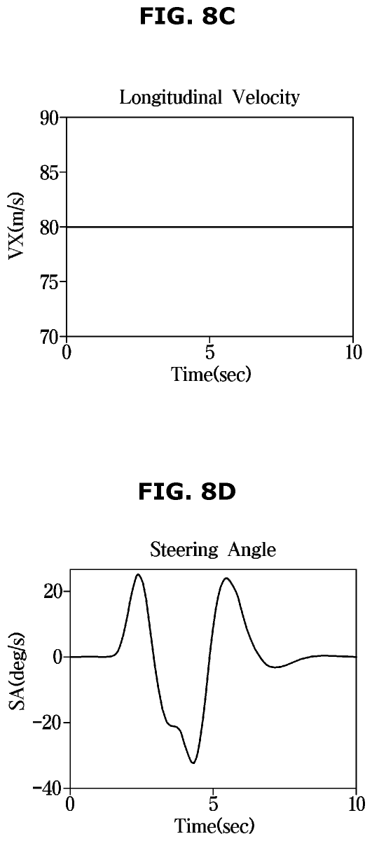

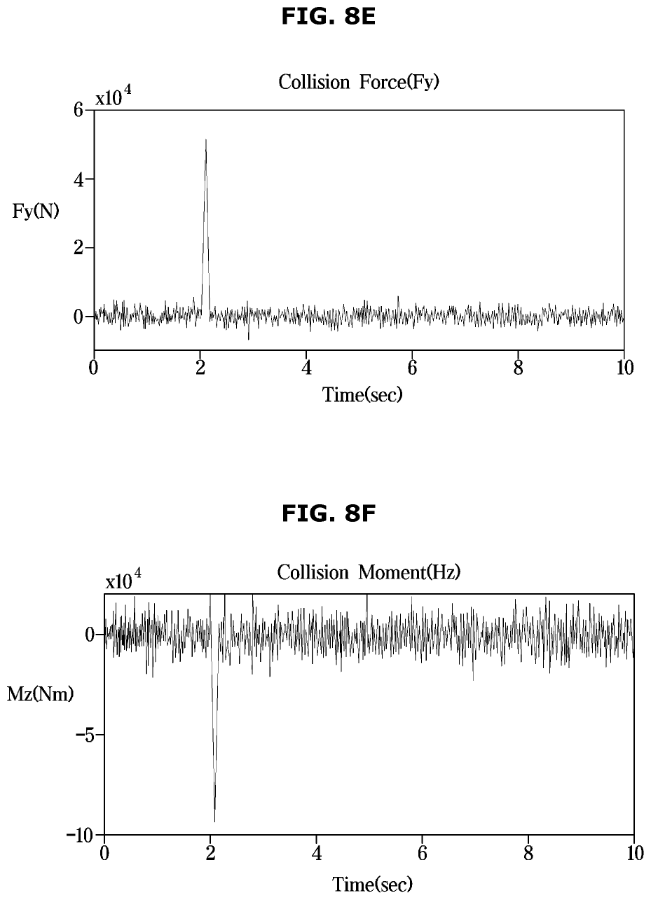

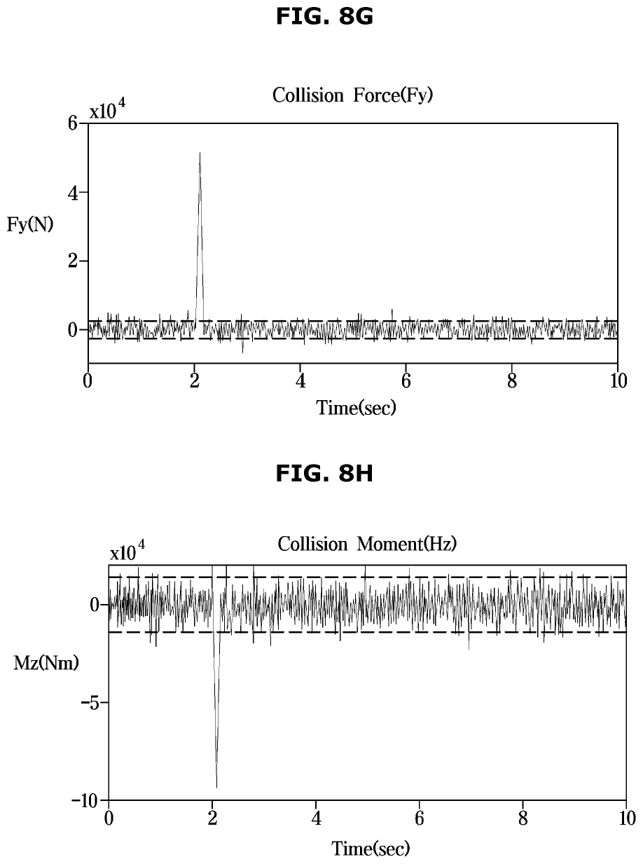

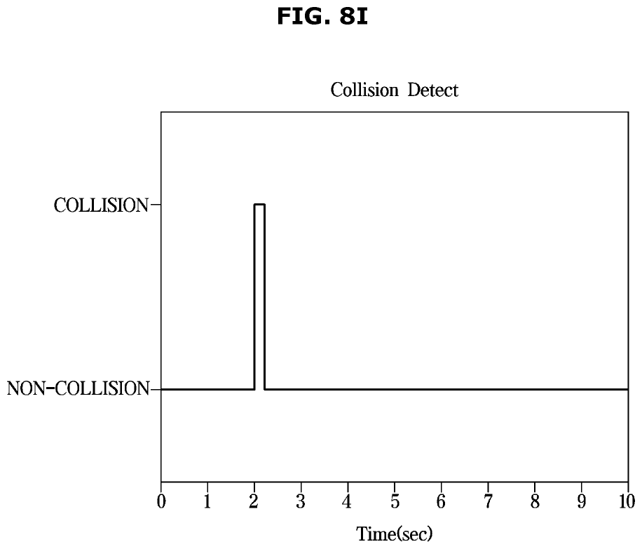

FIG. 8A is a graph illustrating a lateral acceleration with time when driving as described in FIG. 7, FIG. 8B is a graph illustrating a yaw angular velocity with time when driving as described in FIG. 7, FIG. 8C is a graph illustrating a longitudinal velocity with time when driving as described in FIG. 7, and FIG. 8D is a graph illustrating a steering angle with time when driving as described in FIG. 7.

FIG. 8E is a graph illustrating a lateral collision force with time when driving as described in FIG. 7, and FIG. 8F is a graph illustrating a collision moment with time when driving as described in FIG. 7.

FIG. 8G is a graph that compares the lateral collision force of FIG. 8E and a reference collision force, FIG. 8H is a graph that compares the collision moment of FIG. 8F and a reference collision moment, and FIG. 8I is a graph illustrating a collision determination signal determined according to a result of comparing the lateral collision force identified when driving as described in FIG. 7 with the reference collision force and a result of comparing the collision moment identified when driving as described in FIG. 7 with the reference collision moment.

The vehicle 1 according to the embodiment generates a collision signal in response to a collision with another vehicle. Accordingly, the vehicle 1 according to the embodiment may be configured to determine the collision with the other vehicle in response to the generation of the collision signal.

As described above, according to the embodiment, an external force (the lateral collision force and the collision moment) that directly affects the vehicle may be estimated based on an external force estimator based on vehicle dynamics, and when the external force reaches a predetermined boundary value, it may be determined that a collision occurs. Accordingly, a rapid movement of the vehicle without a collision may be prevented from being erroneously determined as collision, and collision determination may be applied when the vehicle moves straight ahead as well as moves laterally such as changing lanes.

The processor 170 may also be implemented as a single processor.

The processor 170 may be a memory (not shown) that stores an algorithm for controlling operations of constituent components of the collision determination device (CD) or data about a program that reproduces the algorithm, and a processor (not shown) that performs the above-described operations using the data stored in the memory. In this instance, the memory and the processor may be provided as one chip, or provided as separate chips.

The processor 170 may be implemented as a memory (not shown) that stores an algorithm for controlling operations of constituent components of the vehicle or data about a program that reproduces the algorithm, and a processor (not shown) that performs the above-described operations using the data stored in the memory. In this instance, the memory and the processor may be provided as one chip, or provided as separate chips.

The memory 171 may be configured to store reference information. Here, the reference information may comprise the reference collision force and the reference collision moment.

The memory 171 may be implemented as at least one of a volatile memory such as a random access memory (RAM), a non-volatile memory such as a cache, a flash memory, a read only memory (ROM), an erasable programmable read only memory (EPROM), an electrically erasable programmable read only memory (EEPROM), or a recording medium such as a hard disk drive (HDD) and a compact disc read only memory (CD-ROM), without being limited thereto.

The memory 171 may be a memory implemented as a separate chip from the processor 170 described above, or a single chip with the processor 170.

The processor 170 may be a processor of an ADAS.

The processor 170 may be a memory (not shown) that stores an algorithm for implementing an operation of the ADAS or data about a program that reproduces the algorithm, and a processor (not shown) that performs the above-described operations using the data stored in the memory.

The communicator 172 may comprise one or more constituent components for enabling communication among devices inside the vehicle 1 and communication between the vehicle 1 and an external device. For example, the communicator 172 may comprise at least one of a short-range communication module, a wired communication module, or a wireless communication module.

The short-range communication module may comprise a variety of short-range communication modules that transmit and receive signals in a short distance using a wireless communication network, such as a Bluetooth module, infrared communication module, radio frequency identification (RFID) communication module, wireless local access network (WLAN) communication module, near-field communication (NFC) communication module, Zigbee communication module, and the like.

The wired communication module may comprise various wired communication modules such as a controller area network (CAN) communication module, local area network (LAN) module, wide area network (WAN) module, value added network (VAN) module, and the like, and also include various cable communication modules such as a universal serial bus (USB), high definition multimedia interface (HDMI), digital visual interface (DVI), recommended standard 232 (RS-232), power line communication, plain old telephone service (POTS), and the like.

The wireless communication module may comprise wireless communication modules that support a variety of communication methods such as a Wi-Fi module, Wireless broadband (Wibro) module as well as global system for mobile communication (GSM), code division multiple access (CDMA), wideband CDMA (WCDMA), universal mobile telecommunications system (UMTS), time division multiple access (TDMA), long term evolution (LTE), and the like.

The communicator 172 may be configured to transmit information detected by various sensors to the processor 170.

The communicator 172 may be configured to transmit a control command of the processor 170 to various devices.

The brake device 180 may be configured to generate a braking force.

The brake device 180 may be configured to decelerate or stop the vehicle 1 through friction with vehicle wheels.

The brake device 180 may comprise an electronic brake control unit. The electronic brake control unit may be configured to control a braking force in response to a driver's braking intention through a brake pedal and/or a wheel slip. For example, the electronic brake control unit may be configured to temporarily release the braking in response to the wheel slip detected when the vehicle 1 is braked (anti-lock braking system, ABS).

The electronic brake control unit may be configured to selectively release the wheel braking in response to oversteering and/or understeering detected when steering the vehicle 1 (electronic stability control, ESC).

Also, the electronic brake control unit may be configured to temporarily brake the wheels in response to the wheel slip detected when driving the vehicle 1 (traction control system, TCS).

The brake device 180 may comprise a prefill part, a pre-braking part, and an emergency braking part that operate in response to relative distance information to an obstacle. Here, the prefill part, the pre-braking part, and the emergency braking part have different relative distances to the obstacle for operation.

The steering device 190 may be a device for changing a driving direction of the vehicle 1.

The steering device 190 may be configured to change the driving direction of the vehicle 1 in response to a driver's steering intention through a steering wheel. The steering device 190 may comprise an electronic steering control unit that may be configured to reduce a steering force during low-speed driving or parking and increase the steering force during high-speed driving.

The vehicle 1 may further comprise a power device for generating a driving force.

In an internal combustion engine vehicle, the power device may comprise an engine and an engine control unit. In an eco-friendly vehicle, the power device may comprise a motor, a battery, a motor control unit, and a battery management device.

In the internal combustion engine vehicle, the power device may be configured to control the engine in response to a driver's acceleration intention through an accelerator pedal. For example, the engine control unit may be configured to control a torque of the engine.

Meanwhile, each of the constituent components illustrated in FIGS. 1 and 2 refer to a software and/or a hardware such as field-programmable gate array (FPGA) and an application specific integrated circuit (ASIC).

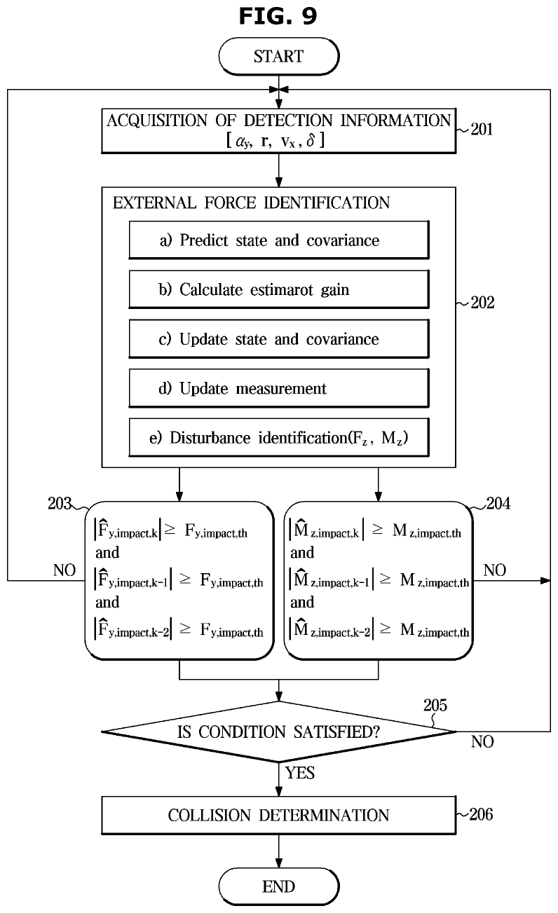

FIG. 9 is a flowchart illustrating a control of the vehicle 1 according to an exemplary embodiment.

The vehicle 1 acquires detection information detected from each of the speed sensor 110, the acceleration sensor 120, the yaw sensor 130 and the steering angle sensor 140 (201).

The vehicle 1 acquires longitudinal velocity information, lateral acceleration information, yaw angular velocity information and steering angle information based on the received detection information, and identifies (202) an external force based on the acquired longitudinal velocity information, lateral acceleration information, yaw angular velocity information and steering angle information. In this instance, the vehicle 1 may be configured to identify a lateral collision force and a collision moment generated in the vehicle 1 as the external force.

The detection information may comprise driving speed information detected by the speed sensor 110, the lateral acceleration information detected by the acceleration sensor 120, the yaw angular velocity information detected by the yaw sensor 130, and the steering angle information detected by the steering angle sensor 140.

The vehicle 1 may be configured to acquire a longitudinal velocity based on the driving speed information.

To describe a configuration of an external force identification of the vehicle 1 in more detail, the vehicle 1 may be configured to predict (a) a state of the vehicle 1 corresponding to a location change of the vehicle 1 and a covariance matrix, and obtain (b) a gain based on the predicted system state covariance matrix p̅, a covariance matrix V for a measurement noise and a discretized form H of an output matrix. In this instance, a Kalman gain may comprise a Kalman gain for a system variable X and a Kalman gain for an estimated disturbance d.

The vehicle 1 may be configured to update (c) the state of the vehicle 1 and the covariance based on a covariance matrix for a model uncertainty W, a discretization matrix of an input matrix G₁, and a discretization matrix of a system matrix F. Also, the vehicle 1 may be configured to correct (d) the measured value and identify (e) a disturbance based on the corrected measured value.

The vehicle 1 may be configured to identify a lateral collision force and a collision moment from the identified external force.

The vehicle 1 compares the identified lateral collision force with a reference collision force (203), and compares the identified collision moment with a reference collision moment (204).

The vehicle 1 periodically (e.g., k, k−1, k−2) compares the identified lateral collision force with the reference collision force, and compares the identified collision moment with the reference collision moment. Here, the period may be a preset time interval.

The vehicle 1 determines whether the identified lateral collision force is greater than or equal to the reference collision force and the identified collision moment is greater than or equal to the reference collision moment. When it is determined that the identified lateral collision force is greater than or equal to the reference collision force and the identified collision moment is greater than or equal to the reference collision moment, the vehicle 1 determines whether a period of time for which the above-described state is maintained is longer than a reference time.

That is, when a condition that the period of time for which the identified lateral collision force is maintained greater than or equal to the reference collision force and the identified collision moment is maintained greater than or equal to the reference collision moment is longer than the reference time is satisfied (205), the vehicle 1 may be configured to determine that a collision of the vehicle 1 occurs (206).

Here, the reference time may be two periods of time (k, k−1, k−2) for which an external force is estimated.

When it is determined that the collision occurs between the vehicle 1 and an obstacle, the vehicle 1 may be configured to control at least one of the brake device 180 or the steering device 190, thereby may be configured to prevent the vehicle 1 from rotating or deviating from a driving lane to prevent an accident.

When it is determined that the identified lateral collision force is less than the reference collision force or the identified collision moment is less than the reference collision moment, the vehicle 1 determines that no collision occurs.

Also, when the period of time for which the identified lateral collision force is maintained greater than or equal to the reference collision force and the identified collision moment is maintained greater than or equal to the reference collision moment is less than the reference time, the vehicle 1 determines that no collision occurs.

As is apparent from the above, according to the embodiments of the disclosure, the collision determination device and the vehicle having the same can estimate an external force (a lateral collision force and a collision moment) that directly affect the vehicle using an external force estimator based on vehicle dynamics and determine whether a collision occurs based on a magnitude of the estimated external force and a time during which the estimated external force acts, thereby can improve an accuracy of collision determination. That is, a rapid movement state of the vehicle without a collision can be determined.

According to the embodiments of the disclosure, the collision determination device and the vehicle having the same can improve an accuracy of collision determination of the vehicle, thereby can prevent a malfunction of an ADAS.

According to the embodiments of the disclosure, the collision determination device and the vehicle having the same can distinguish a collision state from a rapid lateral movement state of the vehicle such as changing lanes or rotating. That is, a collision can be distinguished even in the rapid lateral movement state and an accuracy of collision determination can be improved.

According to the embodiments of the disclosure, the collision determination device and the vehicle having the same can distinguish a collision state from a rapid movement state of the vehicle, thereby can optimally control braking and steering of the vehicle and secure a safety of the vehicle. That is, a safety and adjustability of the vehicle may be secured when the vehicle rotates or deviates from a lane due to a collision, and an occurrence of traffic accidents can be reduced.

According to the embodiments of the disclosure, the collision determination device and the vehicle having the same can determine whether a collision occurs without an added hardware configuration, thereby can prevent an increase in manufacturing cost, improve a quality and a marketability of the vehicle, increase user satisfaction and improve competitiveness.

Embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may comprise read only memory (ROM), random access memory (RAM), magnetic tapes, magnetic disks, flash memories, and optical recording mediums.

Although embodiments have been described for illustrative purposes, those skilled in the art will appreciate that various modifications, additions and substitutions are possible, without departing from the scope and spirit of the disclosure. Therefore, embodiments have not been described for limiting purposes.

What is claimed is:

1. A collision determination device, comprising:
a communicator configured to communicate with a plurality of sensors; and
a processor configured to:
identify a lateral collision force and a collision moment generated in a vehicle based on detection information of the plurality of sensors received through the communicator; and
determine whether a collision of the vehicle occurs based on the lateral collision force and the collision moment.

2. The collision determination device of claim 1, wherein the detection information of the plurality of sensors comprises:
longitudinal velocity information detected by a speed sensor;
lateral acceleration information detected by an acceleration sensor;
yaw angular velocity information detected by a yaw sensor; and
steering angle information detected by a steering angle sensor.

3. The collision determination device of claim 2, wherein the processor is further configured to:
predict a state of the vehicle and a covariance matrix based on the detection information of the plurality of sensors;
calculate a Kalman gain based on the state of the vehicle and the covariance matrix;
correct the state of the vehicle and the covariance matrix based on the Kalman gain, generating a corrected state and a corrected covariance matrix; and
identify the lateral collision force and the collision moment based on the corrected state of the vehicle and the corrected covariance matrix.

4. The collision determination device of claim 1, wherein the processor is further configured to:
determine whether the lateral collision force is greater than or equal to a reference collision force and the collision moment is greater than or equal to a reference collision moment; and
when the lateral collision force is greater than or equal to the reference collision force, determine that the collision of the vehicle occurs.

5. The collision determination device of claim 1, wherein the processor is further configured to:
determine whether the lateral collision force is greater than or equal to a reference collision force and the collision moment is greater than or equal to a reference collision moment;
when a period of time for which the lateral collision force is maintained greater than or equal to the reference collision force is longer than a reference time, determine that the collision of the vehicle occurs, and
when the period of time for which the lateral collision force is maintained greater than or equal to the reference collision force is less than the reference time, determine that no collision occurs in the vehicle.

6. The collision determination device of claim 5, wherein the processor is further configured to determine that no collision occurs in the vehicle when:
the lateral collision force is less than the reference collision force; or
the collision moment is less than the reference collision moment.

7. A vehicle, comprising:
a speed sensor configured to detect a longitudinal velocity;
an acceleration sensor configured to detect a lateral acceleration;
a yaw sensor configured to detect a yaw angular velocity;
a steering angle sensor configured to detect a steering angle; and
a processor configured to:
identify:
a lateral collision force and a collision moment generated in the vehicle based on longitudinal velocity information detected by the speed sensor;
lateral acceleration information detected by the acceleration sensor;
yaw angular velocity information detected by the yaw sensor; and
steering angle information detected by the steering angle sensor; and
determine whether a collision of the vehicle occurs based on the lateral collision force and the collision moment.

8. The vehicle of claim 7, wherein the processor is further configured to:
predict a state of the vehicle and a covariance matrix based on:
the longitudinal velocity information detected by the speed sensor;
the lateral acceleration information detected by the acceleration sensor;
the yaw angular velocity information detected by the yaw sensor; and
the steering angle information detected by the steering angle sensor;
calculate a Kalman gain based on the state of the vehicle and the covariance matrix,
correct the state of the vehicle and the covariance matrix based on the Kalman gain, generating a corrected state and a corrected covariance matrix; and
identify the lateral collision force and the collision moment based on the corrected state of the vehicle and the corrected covariance matrix.

9. The vehicle of claim 7, wherein the processor is further configured to:
determine whether:
the lateral collision force is greater than or equal to a reference collision force; and
the collision moment is greater than or equal to a reference collision moment, and
when the lateral collision force is greater than or equal to the reference collision force, determine that the collision of the vehicle occurs.

10. The vehicle of claim 7, wherein the processor is further configured to:
determine whether:
the lateral collision force is greater than or equal to a reference collision force; and
the collision moment is greater than or equal to a reference collision moment;
when a period of time for which the lateral collision force is maintained greater than or equal to the reference collision force is longer than a reference time, determine that the collision of the vehicle occurs; and
when the period of time for which the lateral collision force is maintained greater than or equal to the reference collision force is less than the reference time, determine that no collision occurs in the vehicle.

11. The vehicle of claim 10, wherein the processor is further configured to determine that no collision occurs in the vehicle when:
the lateral collision force is less than the reference collision force; or
the collision moment is less than the reference collision moment.

12. The vehicle of claim 7, further comprising:
a brake device configured to generate a braking force,
wherein the processor is further configured to control the brake device based on the lateral collision force and the collision moment when it is determined that the collision of the vehicle occurs.

13. The vehicle of claim 7, further comprising:
a steering device configured to change a driving direction of the vehicle,
wherein the processor is further configured to control the steering device based on the lateral collision force and the collision moment when it is determined that the collision of the vehicle occurs.
